(19) United States
(12) Patent Application Publication
(10) Pub. No.: US 2014/0201544 A1
(43) Pub. Date: Jul. 17, 2014

(54) EXTERNAL STORAGE DEVICE AND DRIVING METHOD THEREOF

(71) Applicant: Chen Hsi TAI, New Taipei City (TW)

(72) Inventor: Chen Hsi TAI, New Taipei City (TW)

(21) Appl. No.: 13/941,748

(22) Filed: Jul. 15, 2013

Related U.S. Application Data
(63) Continuation-in-part of application No. 13/740,338, filed on Jan. 14, 2013.

(30) Foreign Application Priority Data
May 22, 2013 (TW) 102209509

(51) Int. Cl. G06F 1/26

(52) U.S. Cl. CPC G06F 1/266
USPC 713/310

(57) ABSTRACT

An external storage device comprises a plurality of hard disks, a bridging control unit, a connecting port and a voltage converter circuit. The bridging control unit is coupled to the hard disks and ingrates the hard disks into a redundant array of independent disks. The connecting port is coupled to the bridging control unit and the hard disks. The voltage converter circuit is coupled to the bridging control unit and the connecting port. The external storage device receives through a transmission line a power supplied from an electronic device. The power is transmitted through the connecting port directly to the hard disks in order to drive the hard disks. The voltage converter circuit converts the power and supplies the power to the bridging control unit. It is convenient for user to disconnect an extra power supply apparatus and a voltage transformer.

### CROSS REFERENCE TO RELATED APPLICATION

This application is a continuation-in-part of U.S. application Ser. No. 13/740,338, filed on 14 Jan. 2013 and entitled “External Storage Device and Driving Method Thereof”, now pending, the entire disclosures of which are incorporated herein by reference.

### BACKGROUND

1. Technical Field

The present disclosure relates to an external storage device and a driving method of the external storage device, in particular, to an external storage device with a plurality of hard disks and a driving method of the external storage device.

2. Description of Related Art

With the technology development, the computer multimedia flourishes rapidly. Therefore, the need of data storage capacity for people is increasing day by day, and the need of external storage devices is increasing, too. For example, the external storage device can be a 500 G or 1 T portable hard disk, and can store more data that are multimedia.

In addition, although notebooks and desktops become universal, the originally equipped storage capacity of hard disks in these notebooks and desktops are small, or the hard disks are not portable, so the need of 2.5-inch external storage devices is getting popular for people. Moreover, since the volumes of 2.5-inch external storage devices are very small, the using probability of 2.5-inch external storage devices becomes larger.

However, a common external storage device always comprises a transformer. After the common external storage device is connected to an electronic device through a transmission line, the electronic device transmits a power to the common external storage device. Due to the insufficient provided current from the electronic device, the common external storage device is not able to be driven. Therefore, a designer of a common external storage device always interdicts the power provided from the electronic device into the common external storage device, and the designer takes a transformer as the main power source to provide a 5 volts/2 amps or a 12 volts/2 amps power to the external storage device. In addition, the transformer still needs to supply a power for the control chip, such that the power from the transformer needs to be reduced to a lower voltage through a buck converter circuit. Therefore, the circuit design of the common external storage drive is very complex, and the common external storage device consumes more power. As a result, it causes large loss of power virtually.

Therefore, how to effectively provide the required power to the external storage device and simply the design of the drive circuit is an important issue at the present day.

### SUMMARY

An exemplary embodiment of the present disclosure provides an external storage device and a driving method of the external storage device to solve the above-mentioned problems.

The present invention provides an external storage device, and the external storage device comprises a plurality of hard disks, a control unit, a bridging unit, a connecting port and a voltage converter circuit. The control unit is electrically coupled to the hard disks for integrating the hard disks into a plurality of redundant array of independent disks (RAID's). The bridging unit is coupled to the control unit for converting a Universal Serial Bus (USB) signal into a Serial Advanced Technology Attachment (SATA) signal. The connecting port is electrically coupled to the hard disks. The voltage converter circuit is coupled to the control unit and the bridging unit. The external storage device receives a power provided from an electronic device through a transmission line, and the power is directly transmitted to the hard disks through the connecting port to drive the hard disks. The voltage converter circuit converts a power and supplies the power to the control unit and the bridging unit.

According to an exemplary embodiment of the present disclosure, the above-mentioned transmission line is a Y-shaped transmission line and comprises a first connection interface, a second connection interface and a third connection interface. The first connection interface is electrically coupled to the connecting port. The second connection interface and the third connection interface are electrically coupled to the output-connecting port of the electronic device. A specification of the connecting port is USB 3.0 or USB 2.0, a specification of the second connection interface is USB 3.0, and a specification of the third connection interface is USB 3.0 or USB 2.0.

According to an exemplary embodiment of the present disclosure, the above-mentioned voltage converter circuit converts a power into a first voltage, a second voltage and a third voltage. The voltage converter circuit provides the first voltage and the second voltage to the control unit, and provides the first voltage and the third voltage to the bridging unit.

According to an exemplary embodiment of the present disclosure, the above-mentioned voltage converter circuit comprises a first converter element, a second converter element and a third converter element, while the first converter element is electrically coupled between the second converter element and the third converter element.

According to an exemplary embodiment of the present disclosure, the above-mentioned first converter element is a pulse wave modulator or a low voltage-drop regulator, the above-mentioned second converter element is a pulse wave modulator or a low voltage-drop regulator, and the third converter element is a pulse wave modulator or a low voltage-drop regulator.

According to an exemplary embodiment of the present disclosure, the above-mentioned voltage converter circuit comprises a fourth converter element and a fifth converter element. The fourth converter element is electrically coupled to the fifth converter element.

According to an exemplary embodiment of the present disclosure, the above-mentioned fourth converter element is a dual-output-port pulse wave modulator, and the fifth converter element is a low voltage-drop regulator. A port of the fourth converter element is electrically coupled to the fifth converter element.

According to an exemplary embodiment of the present disclosure, the above-mentioned fourth converter element is a low voltage-drop regulator, and the fifth converter element is a dual-output-port pulse wave modulator. The fourth converter element is electrically coupled to an input-port of the fifth converter element.

According to an exemplary embodiment of the present disclosure, the above-mentioned bridging unit is used for converting the USB signal into the SATA signal, and transmits the SATA signal to the control unit. The control unit comprises a RAID controller for integrating a plurality of hard disks into the RAID's. The RAID controller divides the RAID's into different storage modes to provide better transmission efficiency and to achieve data backup function, wherein each of the hard disks is a 2.5-inch hard disk.

The present invention provides a driving method of an external storage device, and the driving method comprises steps of: providing a transmission line coupled between an external storage device and an electronic device; determining whether a connecting port of the external storage device receives a power supplied by the electronic device; if the connecting port of the external storage device receives the power supplied from the electronic device, the power is transmitted directly to the hard disks through the connecting port; and by using a voltage converter circuit of the external storage device, converting the power and supplying the power to the control unit and the bridging unit.

The present invention provides an external storage device, and the external storage device comprises a plurality of hard disks, a bridging control unit, a connecting port and a voltage converter circuit. The bridging control unit is electrically coupled to the hard disks for integrating the hard disks into a plurality of redundant array of independent disks (RAID's). The connecting port is coupled to the bridging control unit and the hard disks. The voltage converter circuit is coupled to the bridging control unit and the connecting port. The external storage device receives a power provided from an electronic device through a transmission line, and the power is directly transmitted to the hard disks through the connecting port to drive the hard disks. The voltage converter circuit converts the power and supplies the power to the bridging control unit.

According to an exemplary embodiment of the present disclosure, furthermore comprises a community unit, the community unit is electrically coupled to the bridging control unit, while the community unit is used to wirelessly receive and/or transmit a data signal.

To sum up, the present disclosure is characteristic in that the power provided from an electronic device is directly supplied to the hard disks, and the power through the voltage converter circuit is converted into suitable voltages to meet the voltage requirements of the control unit and the bridging unit (or the bridging control unit), such that the control unit (or the bridging control unit) can control the data access of the hard disks. By the above-mentioned mechanisms, the design of the driving circuit of the external storage device can be simplified. Moreover, the energy usage and the energy-saving efficiency can also be promoted.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 is a function block diagram of an external storage device according to an exemplary embodiment of the present disclosure;

FIG. 2 is a function block diagram of an external storage device according to another exemplary embodiment of the present disclosure;

FIG. 3 is a function block diagram of an external storage device according to another exemplary embodiment of the present disclosure;

FIG. 4 is a function block diagram of an external storage device according to another exemplary embodiment of the present disclosure;

FIG. 5 is a flow chart of a driving method of an external storage device according to another exemplary embodiment of the present disclosure;

FIG. 6 is a function block diagram of an external storage device according to another exemplary embodiment of the present disclosure;

FIG. 7 is a function block diagram of an external storage device according to another exemplary embodiment of the present disclosure;

FIG. 8 is a function block diagram of an external storage device according to another exemplary embodiment of the present disclosure; and

FIG. 9 is a function block diagram of an external storage device according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### First Exemplary Embodiment

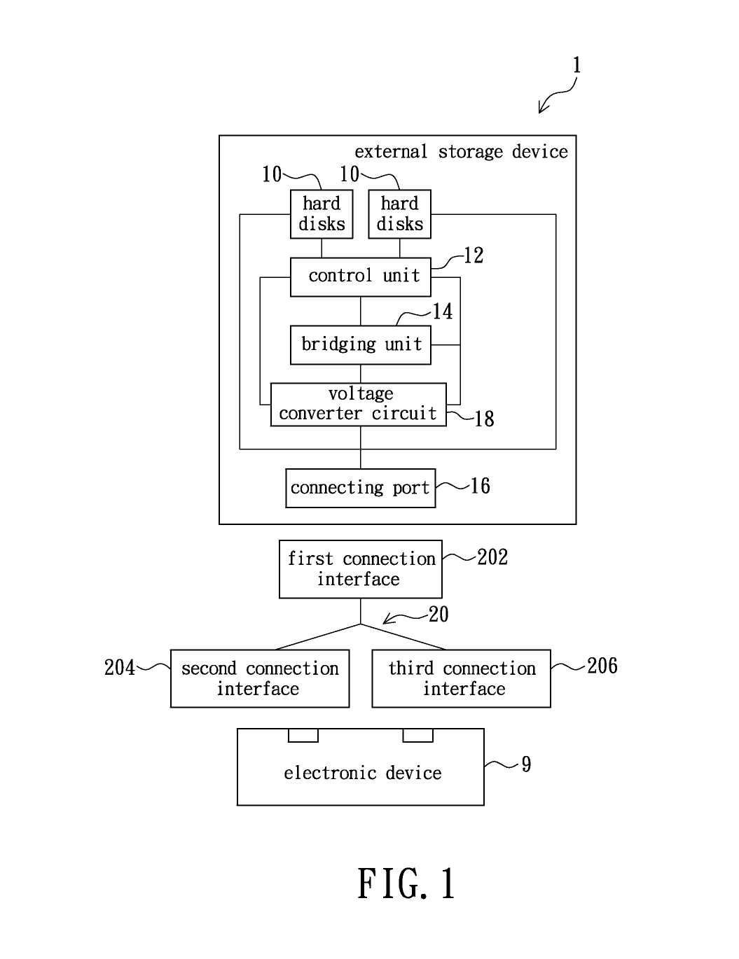

Please refer to FIG. 1. FIG. 1 is a function block diagram of an external storage device according to an exemplary embodiment of the present disclosure. An external storage device 1 comprises a plurality of hard disks 10, a control unit 12, a bridging unit 14, a connecting port 16, a voltage converter circuit 18 and a transmission line 20. In practice, the external storage device 1 is coupled to the electronic device 9 through the transmission line 20, and the electronic device 9 is such a device as a computer, a notebook or a tablet PC. Therefore, the electronic device 9 can perform data access and data backup operations for the external storage device 1.

The transmission line 20 such as a Y-shaped transmission line comprises a first connection interface 202, a second connection interface 204 and a third connection interface 206. The first connection interface 202 is coupled to the connecting port 16. The second connection interface 204 and the third connection interface 206 are coupled to the output-connecting port of the electronic device 9. The second connection interface 204 is USB 3.0, and the third connection interface 206 is USB 3.0 or USB 2.0. In another exemplary embodiment, the transmission line 20 may be a single cable transmission line. For example, the second connection interface 204 and the third connection interface 206 may be disposed in an identical connector. The said identical connector is coupled to a single output-connecting port of the electronic device 9. Thus, the said identical connector may provide a current (more than 1400 mA), to drive the operation of the external storage device 1. Furthermore, the said single cable transmission line may comprise a first connection interface 202 and a second connection interface 204. The first connection interface 202 is electrically coupled to the connecting port 16, and a specification of the first connection interface 202 is USB 3.0. The second connection interface 204 is electrically coupled to an output-connecting port of electronic devices 9, and a specification of the second connection interface 204 is USB 3.0. The exemplary embodiment of the present disclosure doesn't limit the Y-shaped transmission line 20 types of the first connection interface 202, the second connection interface 204 and the third connection interface 206.

In detail, the specification of USB 3.0 can provide a 900 mA current, and the specification of USB 2.0 can provide a 500 mA current. Therefore, the second connection interface 204 and the third connection interface 206 can provide a current (more than 1400 mA), and the 1400 mA current is enough to drive the operation of the external storage device 1.

The external storage device 1 doesn't use complex circuit design of a transformer, thereby the loss of energy is reduced. According to the power provided from the electronic device 9, the driving circuit of the external storage device 1 can be simplified to realize data access operations in the external storage device 1.

An exemplary embodiment of the present disclosure provides a plurality of hard disks 10, such as a 2.5-inch SATA hard disk, and the number of the hard disks 10 is two. The exemplary embodiment of the present disclosure does not limit the number of the hard disks 10. In practice, the SATA hard disk can be a hard disk conforming to SATA I (1.5 GB/s), SATA II (3.0 GB/s), or SATA III (6.0 GB/s) which is already mentioned in the above-specifications. A SATA hard disk has physical memory blocks to store data, and then the hard disks 10 can be used for data access and data backup.

The control unit 12 is coupled between the hard disks 10 and the bridging unit 14 for arranging the hard disks 10 into a plurality of redundant arrays of independent disks, and the control unit 12 is such a chip as a Silicon Image 5923 chip. The exemplary embodiment of the present disclosure doesn't limit the type of the control unit 12. The control unit 12 receives the SATA signal transmitted from the bridging unit 14 to control the hard disks 10 and operate data access and data backup thereof.

In addition, the control unit 12 uses Redundant Array of Independent Disks (RAID) technology to integrate a plurality of small-capacity hard disks into an extendable logical drive, wherein the logical drive can be divided into a plurality of redundant arrays of independent disks. When the control unit 12 saves data, the data is divided into a plurality of data blocks, and then the data blocks are dividedly stored in the hard disks. Because the operation of data access can be done simultaneously, RAID technology can provide a better efficiency for data access. In order to avoid the loss of data caused by the damage of a hard disk, RAID technology uses the concept of parity check to assist the reconstruction of necessary data.

The bridging unit 14 is coupled between the control unit 12 and the connecting port 16 for converting the USB signal into SATA signal, and provides SATA signal to the control unit 12. The bridging unit 14 such as an ASmedia 1051 chip conforms to SATA I (1.5 GB/s), SATA II (3.0 GB/s), or SATA III (6.0 GB/s) which is already mentioned in the above-specifications. The exemplary embodiment of the present disclosure doesn't limit the type of the bridging unit 14. Of course, the bridging unit 14 can integrate a voltage regulator used for regulating 3.3V to 1.2V. For example, the bridging unit 14 can integrate a 1.2V voltage regulator, so the voltage converter circuit 18 can provide 3.3V voltage directly to the bridging unit 14, and then the 3.3V voltage can be regulated into a 1.2V voltage through the 1.2V voltage regulator in the bridging unit 14. Therefore, the complexity of the circuit design of the voltage converter circuit 18 can be simplified.

The connecting port 16 is coupled between the hard disks 10 and the transmission line 20 for receiving a power supplied from the electronic device 9, and then provides the power directly to the hard disks 10. In practice, the connecting port 16 is such as a USB 2.0 or USB 3.0, whereby the electronic device 9 can provide a USB signal to the bridging unit 14 and provide a power to the hard disks 10 through the connecting port 16.

The voltage converter circuit 18 is coupled to the control unit 12, the bridging unit 14, and the connecting port 16. For example, the voltage converter circuit 18 is a combination of a pulse wave modulator and a low voltage-drop regulator. The voltage converter circuit 18 is used for providing a voltage to the control unit 12 and the bridging unit 14. For example, the voltage requirements of the control unit 12 are 3.3V and 1.8V, and the voltage requirements of the bridging unit 14 are 3.3V and 1.2V. By the voltage converter circuit 18, the 3.3V voltage is provided to the control unit 12 and the bridging unit 14, the 1.8V voltage is provided to the control unit 12, and the 1.2V voltage is provided to the bridging unit 14. The exemplary embodiment of the present disclosure doesn't limit the type of the voltage converter circuit 18.

In detail, the control unit 12 and the bridging unit 14 require two different voltages, respectively. When the external storage device 1 is coupled to the electronic device 9 through the transmission line 20, and the electronic device 9 detects the type of the external storage device 1 to recognize which communication protocol USB 2.0 or USB 3.0 is used by the external storage device 1. Both the control unit 12 and the bridging unit 14 are required to performed signal conversion to output SATA signal, therefore they consume more power. Based on the above-mentioned reasons, the control unit 12 and the bridging unit 14 are provided with two different voltages to let the external storage device 1 operate normally.

According to the above-mentioned reasons, the external storage device 1 of the present disclosure receives a power provided from the electronic device 9 through the transmission line 20, and then the power is transmitted and supplied directly to the hard disks 10 through the connecting port 16 to drive the hard disks 10. In addition, the voltage converter circuit 18 of the present disclosure converts voltages into suitable voltages to meet the voltage requirements of the control unit 12 and the bridging unit 14. In this way, the control unit 12 can provide SATA signal to control the hard disks 10 to operate data access and data backup. By the above-mentioned mechanisms, the driving circuit design of the external storage device 1 can be simplified, and the using of energy and the efficiency of energy-saving can also be promoted.

### Second Exemplary Embodiment

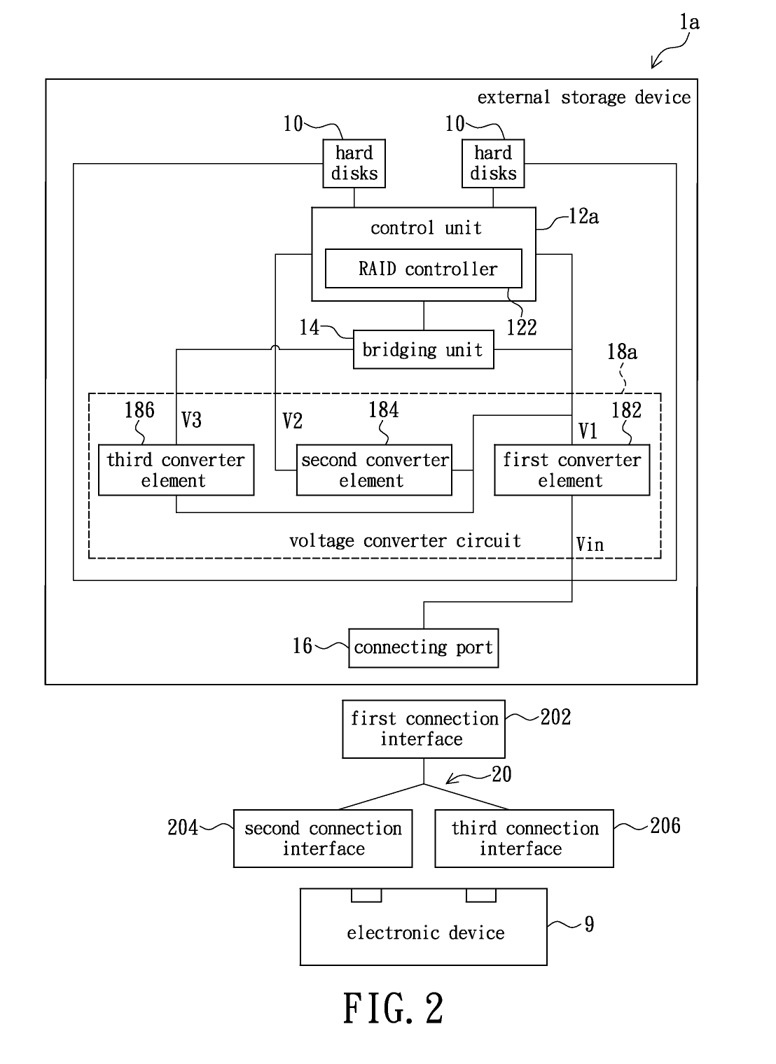

Please refer to FIG. 2. FIG. 2 is a function block diagram of an external storage device according to another exemplary embodiment of the present disclosure. The structures of the external storage device 1a (in FIG. 2) and the external storage device 1 (in FIG. 1) are similar to each other. The difference between the external storage device 1a and the external storage device 1 are that: the voltage converter circuit 18a comprises a first converter element 182, a second converter element 184, and a third converter element 186, wherein the first converter element 182 is coupled to the second converter element 184 and the third converter element 186; the second converter element 184 is coupled to the control unit 12a; and the third converter element 186 is coupled to the bridging unit 14.

In practice, the first converter element 182 is a pulse wave modulator or a low voltage-drop regulator, the second converter element 184 is a pulse wave modulator or a low voltage-drop regulator, and the third converter element 186 is a pulse wave modulator or a low voltage-drop regulator. Therefore, the number of the combinations of the first converter element 182, the second converter element 184, and the third converter element 186 is eight. Each combination can provide voltages required by the control unit 12a and the bridging unit 14. The exemplary embodiment of the present disclosure merely proposes one embodiment to introduce the contents of the present disclosure. Those skilled in the art should be able to deduce the other embodiments about using a pulse wave modulator or a low voltage-drop regulator to change the combinations of the first converter element 182, the second converter element 184, and the third converter element 186 according to the disclosure of the present invention, and the description is omitted.

In addition, the power of the voltage converter circuit 18a is converted to a first voltage V1, a second voltage V2, and a third voltage V3. The voltage converter circuit 18a provides a first voltage V1 and a second voltage V2 to the control unit 12a, and provides a first voltage V1 and the third voltage V3 to the bridging unit 14. The exemplary embodiment of the present disclosure doesn't limit the values of the first voltage V1, the second voltage V2, and the third voltage V3. Those skilled in the art should be able to deduce the other embodiments according to their actual demands.

For example, the first converter element 182 is a first pulse wave modulator, the second converter element 184 is a low voltage-drop regulator, and the third converter element 186 is a second pulse wave modulator. The first pulse wave modulator and the second pulse wave modulator have an input port and an output port respectively, and the low voltage-drop regulator also has an input port and an output port. The first pulse wave modulator is coupled to the low voltage-drop regulator and the second pulse wave modulator, the low voltage-drop regulator is coupled to the control unit 12a, and the second pulse wave modulator is coupled to the bridging unit 14.

In detail, the first converter element 182 is a pulse wave modulator to output the first voltage V1, and the first voltage V1 is supplied to the control unit 12a, the bridging unit 14, the second converter element 184, and the third converter element 186. The second converter element 184 receives the first voltage V1 and converts it into the second voltage V2, and provides the second voltage V2 to the control unit 12a. The third converter element 186 receives the first voltage V1 and converts it into the third voltage V3, and provides the third voltage V3 to the bridging unit 14.

For example, the connecting port 16 receives 5V voltage provided from the electronic device 9, and the 5V voltage is supplied to the hard disks 10 to drive and operate the hard disks 10 normally. The first converter element 182 receives the power and converts it into the first voltage V1 (3.3 V), and the first voltage V1 is supplied to the control unit 12a, the bridging unit 14, the second converter element 184, and the third converter element 186. The second converter element 184 receives the first voltage V1 and converts it into the second voltage V2 (1.8 V), and the second voltage V2 is supplied to the control unit 12a. The third converter element 186 receives the first voltage V1 and converts it into the third voltage V3 (1.2 V), and the third voltage V3 is supplied to the bridging unit 14.

In particular, the control unit 12a comprises a RAID controller 122 used for transmitting the SATA signal to each of the hard disks 10, and then the hard disks 10 can be integrated into a plurality of redundant arrays of independent disks. In practice, storage modes of the redundant array of independent disks have many different types, such as RAID0, RAID1, RAID0+1, RAID2, RAID3, RAID4, RAID5, RAID6, RAID7, RAID10, RAID30 and RAID50 of different RAID applications levels. The electronic device 9 takes the hard disks 10 as a hard disk or a logical storage drive. Of course, the RAID controller 122 also has functions for enhancing data integration, strengthening fault tolerance, and expanding capacity, thereby integrating the hard disk into a plurality of redundant arrays of independent disks. The redundant arrays of independent disks can be divided into different storage modes to achieve more effective transmission efficiency and data guard function to protect the information security of the hard disks 10.

Accordingly, those skilled in the art should know that the basic operation of the second exemplary embodiment is essentially the same as the first exemplary embodiment, and should be able to infer the operation associated with the second exemplary embodiment, further descriptions are therefore omitted.

### Third Exemplary Embodiment

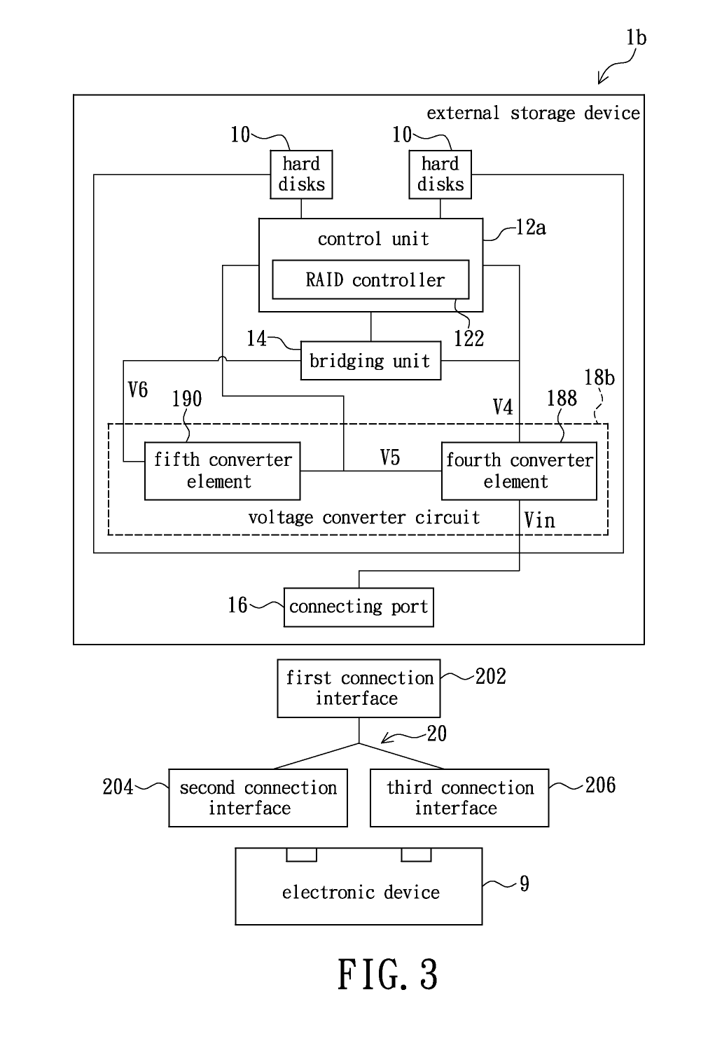

Please refer to FIG. 3. FIG. 3 is a function block diagram of an external storage device according to another exemplary embodiment of the present disclosure. The structures of the external storage device 1b (in FIG. 3) and the external storage device 1 (in FIG. 1) are similar to each other. For example, the external storage device 1b also can receive a power provided from the electronic device 9 and supply the power directly to each of the hard disks 10. However, there are still some differences between the external storage device 1b and the external storage device 1, and these differences are that: the voltage converter circuit 18b comprises a fourth converter element 188 and a fifth converter element 190, wherein the fourth converter element 188 is coupled to the connecting port 16, the fifth converter element 190, the bridging unit 14, and the control unit 12a; the fifth converter element 190 is coupled to the fourth converter element 188 and the bridging unit 14.

In detail, the fourth converter element 188 is a dual-output-port pulse wave modulator for outputting the first voltage V4 and the second voltage V5 separately. The first voltage V4 is supplied to the control unit 12a and the bridging unit 14. The second voltage V5 is supplied to the control unit 12a and the fifth converter element 190. The fifth converter element 190 is a low voltage-drop regulator for receiving the second voltage V5, converting the second voltage V5 into the third voltage V6. The third voltage V6 is supplied to the bridging unit 14.

For example, the connecting port 16 receives 5V voltage provided from the electronic device 9, and the 5V voltage is supplied to the hard disks 10 to drive and operate the hard disks 10 normally. The fourth converter element 188 receives the power and converts it into the first voltage V4 (3.3 V) and the second voltage V5 (1.8 V). The first voltage V4 is supplied to the control unit 12a and the bridging unit 14. The second voltage V5 is supplied to the control unit 12a. In addition, the fifth converter element 190 receives the second voltage V5 and converts it into the third voltage V6 of 1.2 volts. The third voltage V6 is supplied to the bridging unit 14.

Accordingly, those skilled in the art should know that the basic operation of the third exemplary embodiment is essentially the same as the first exemplary embodiment, and should be able to infer the operation associated with the third exemplary embodiment, further descriptions are therefore omitted.

### Fourth Exemplary Embodiment

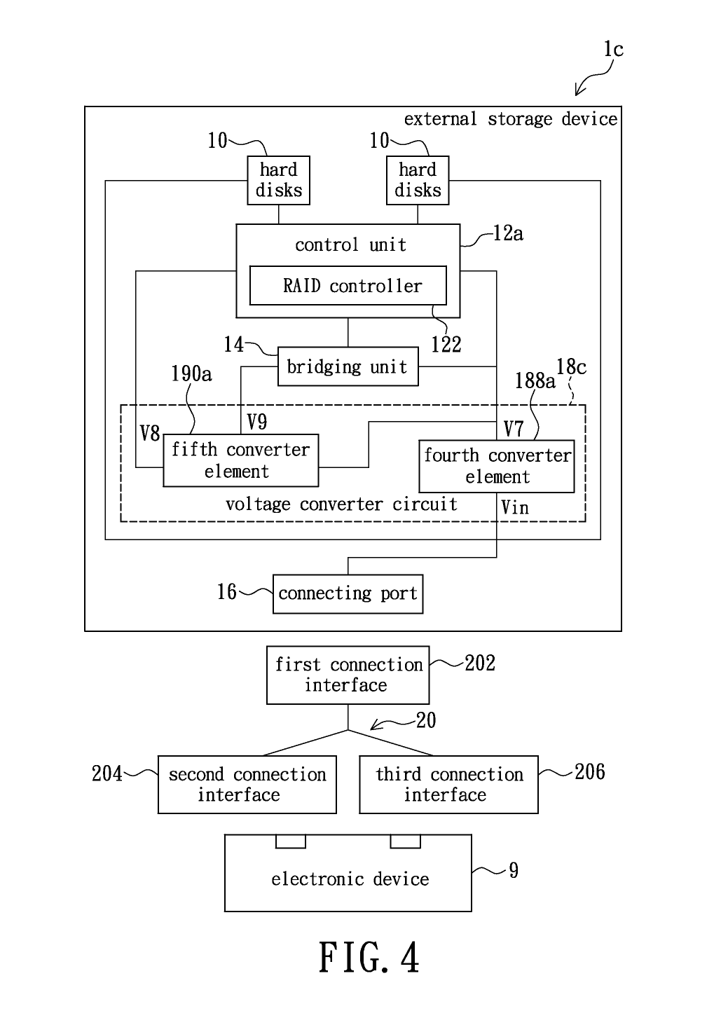

Please refer to FIG. 4. FIG. 4 is a function block diagram of an external storage device according to another exemplary embodiment of the present disclosure. The structures of the external storage device 1c (in FIG. 4) and the external storage device 1 (in FIG. 1) are similar to each other. For example, the external storage device 1c also can receive a power provided from the electronic device 9 and supply the power directly to each of the hard disks 10. However, there are still some differences between the external storage device 1c and the external storage device 1, and these differences are that: the voltage converter circuit 18c comprises a fourth converter element 188a and a fifth converter element 190a, wherein the fourth converter element 188a is coupled to the connecting port 16, the fifth converter element 190a, the bridging unit 14 and the control unit 12a; the fifth converter element 190a is coupled to the fourth converter element 188a, the control unit 12a and the bridging unit 14.

In detail, the fourth converter element 188a is a low voltage-drop regulator and the fifth converter element 190a is a dual-output-port pulse wave modulator. The fourth converter element 188a is coupled to one input-port of the fifth converter element 190a, and the fifth converter element 190a receives the first voltage V7 transmitted by the fourth converter element 188a. The fifth converter element 190a converts the first voltage V7 into the second voltage V8 and the third voltage V9.

For example, the connecting port 16 receives 5V voltage provided from the electronic device 9, and the 5V voltage is supplied to the hard disks 10. The fourth converter element 188a receives the power and converts it into the first voltage V7 (3.3 V). The first voltage V7 is supplied dividedly to the fifth converter element 190a, the control unit 12a, and the bridging unit 14, wherein the fifth converter element 190a converts the first voltage V7 into the second voltage V8 (1.8 V) and the third voltage V9 (1.2 V), the second voltage V8 (1.8 V) is provided to the control unit 12a, and the third voltage V9 (1.2 V) is provided to the bridging unit 14.

Accordingly, those skilled in the art should know that the basic operation of the fourth exemplary embodiment is essentially the same as the first exemplary embodiment, and should be able to infer the operation associated with the fourth exemplary embodiment, further descriptions are therefore omitted.

### Fifth Exemplary Embodiment

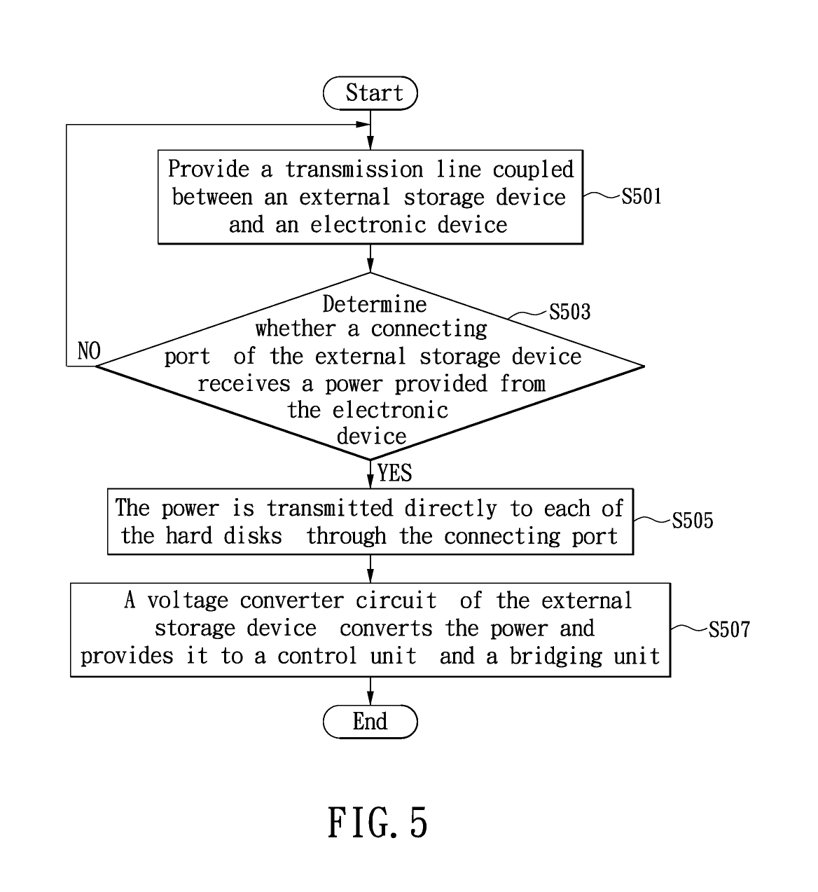

Please refer to FIG. 5 in conjunction with FIG. 1. FIG. 5 is a flow chart of a driving method of an external storage device according to another exemplary embodiment of the present disclosure. First, at step S501, an exemplary embodiment of the present disclosure provides a transmission line 20 coupled between an external storage device 1 and an electronic device 9. In practice, the transmission line 20 may be a Y-shaped transmission line, wherein two connection interfaces of the Y-shaped transmission line are coupled to the electronic device 9 and one connection interface of the Y-shaped transmission line is coupled to the external storage device 1, whereby the electronic device 9 can provide a current (more than 1400 mA) to the external storage device 1. At step S503, it is determined whether a connecting port 16 of the external storage device 1 receives a power provided from the electronic device 9, if it does, step S505 will be operated, if it doesn't, the transmission line 20 will be reinserted between the external storage device 1 and the electronic device 9, and step S501 will be operated again.

When the connecting port 16 of the external storage device 1 receives the power provided from the electronic device 9. At step S505, the power is transmitted directly to each of the hard disks 10 through the connecting port 16. In practice, in order to drive the hard disks 10, a higher voltage and current is required. Hence, the power provided from the electronic device 9 is directly supplied to drive and operate the hard disks 10 normally. The power will be converted into suitable voltages through the voltage converter circuit 18 to meet the voltage requirements of the control unit 12 and the bridging unit 14.

At step S507, a voltage converter circuit 18 of the external storage device 1 converts the power and provides it to a control unit 12 and a bridging unit 14. In practice, the control unit 12 needs two different voltages, and the values of two different voltages are 3.3V and 1.8V separately. The bridging unit 14 also needs two different voltages, and the values of two different voltages are 3.3V and 1.2V. Thus, the control unit 12 can integrate the hard disks 10 into a redundant array of independent disks, thereby providing different operation modes to the hard disks 10 in order to achieve more effective transmission efficiency and data guard function to protect the information security of the hard disks 10. Simultaneously, the control unit 12 controls the hard disks 10 to operate data access and data backup, and the bridging unit 14 converts a USB signal into a SATA signal.

Accordingly, the driving method of the external storage device 1 is to receive a power through the electronic device 9, thus the external storage device 1 gets the maximum efficiency by using the provided power. Of course, the driving circuit of the external storage device 1 is designed by the simplest way to promote the using of energy and the efficiency of energy-saving.

### Sixth Exemplary Embodiment

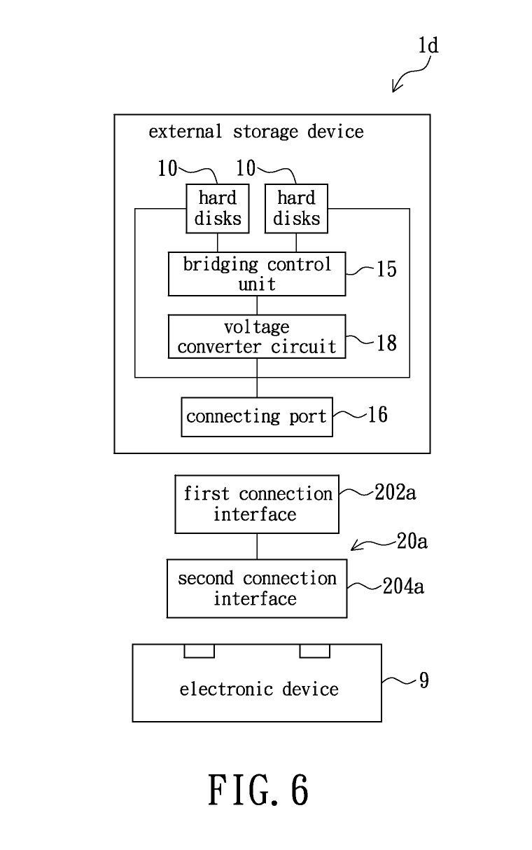

FIG. 6 is a function block diagram of an external storage device according to another exemplary embodiment of the present disclosure. Please refer to FIG. 6. The structures of the external storage device 1d (in FIG. 6) and the external storage device 1 (in FIG. 1) are similar to each other, while the same elements of both storage devices could be indicated by the same reference numerals in the following exemplary embodiment.

An external storage device 1d comprises a plurality of hard disks 10, a bridging control unit 15, a connecting port 16, a voltage converter circuit 18 and a transmission line 20a. In practice, the external storage device 1d is coupled to the electronic device 9 through transmission line 20a, while the electronic device 9 can control data access and data backup operations in the external storage device 1d.

The transmission line 20a such as a single cable transmission line comprises a first connection interface 202a and a second connection interface 204a. The first connection interface 202a is coupled to the connecting port 16, and the second connection interface 204a is coupled to the output-connecting port of the electronic device 9. The second connection interface 204a is USB 3.0 or USB 2.0. The type of the transmission line 20a of the present invention is not limited. In another exemplary embodiment, the transmission line 20a may be a Y-shaped transmission line, and those skilled in the art may perform a free design according to requirement.

In detail, the specification of USB 3.0 can provide a 900 mA current, and the specification of USB 2.0 can provide a 500 mA current. Therefore, when the transmission line 20a may be the Y-shaped transmission line, the transmission line 20a could transport a current of exceeding 1000 mA (1400 mA or 1800 mA); or when the transmission line 20a may be the single cable transmission line, the transmission line 20a could transport a current of exceeding 500 mA or 900 mA based on the specification of USB 2.0 or USB 3.0 respectively, while the external storage device 1d is driven and worked. The magnitude of current for driving the external storage device 1d is not limited in the present invention.

For example, the connecting port 16 receives a 500 mA current provided from the electronic device 9, and the said 500 mA current is supplied to the hard disks 10 to drive and operate the hard disks 10 normally. The exemplary embodiment uses a shunting technology, such as some bigger shunt paths and some smaller shunt paths, which are designed into the circuit. For example, the hard disks 10 may get a max current, such as 300 mA, so that the rest 200 mA current may transport to the voltage converter circuit 18, such as a pulse wave modulator and/or a low voltage-drop regulator. Then the voltage converter circuit 18 converts voltages to the bridging control unit 15a, so as to drive and operate the external storage device 1d normally.

The bridging control unit 15 is coupled between the hard disks 10 and the voltage converter circuit 18, and is used for arranging the hard disks 10 into a plurality of redundant arrays of independent disks. The bridging control unit 15 may be, for instance, FUJITSU MB86E501 chip, and the exemplary embodiment of the present disclosure doesn't limit the type of the bridging control unit 15. For example, the bridging control unit 15 comprises multiple function blocks, wherein the bridging control unit 15 of the exemplary embodiment comprises a bridge block (not shown) and a control block (not shown). However, the type of the bridging control unit 15 comprising multiple function blocks is not limited in the exemplary embodiment, and those skilled in the art may perform a free design according to requirement.

Furthermore, the bridging control unit 15 may integrate a voltage regulator of 3.3 volts or 1.2 volts, such as the bridge block (not shown) of the bridging control unit 15 that integrates with a voltage regulator of 1.2 volts. Thus, the voltage converter circuit 18 doesn't provides 1.2 volts voltage to the bridging control unit 15, and the voltage converter circuit 18 may provide 3.3 volts voltage to the bridge block (not shown). Therefore, the voltage converter circuit 18 may omit a circuit for providing 1.2 volts voltage, so as to streamline complex circuit design of the voltage converter circuit 18.

The connecting port 16 is coupled between the hard disks 10 and the transmission line 20a, and is an interface for receiving a power supplied from the electronic device 9, so that the power is directly provided via the connecting port 16 to the hard disks 10. In practice, the connecting port 16 may be a USB 2.0 or USB 3.0, whereby the electronic device 9 can provide a USB signal to the bridging control unit 15 and provide a power to the hard disks 10 through the connecting port 16.

The voltage converter circuit 18 is coupled to the bridging control unit 15 and the connecting port 16. In practice, the voltage converter circuit 18 may provide one set or two sets of voltage to the bridging control unit 15. For example, the bridging control unit 15 comprises a circuit design for converting 3.3 volts voltage to 1.2 volts voltage, so that the bridging control unit 15 may receive one set of voltage provided by the voltage converter circuit 18, while the voltage converter circuit 18 may be a pulse wave modulator or a low voltage-drop regulator.

In another exemplary embodiment, the voltage converter circuit 18 may provide two sets of voltage to the bridging control unit 15, for example, the bridging control unit 15 comprises two sets of voltage requirements of 3.3 volts and 1.2 volts, while the voltage converter circuit 18 may be any combination of a pulse wave modulator and a low voltage-drop regulator; or a dual-output-port pulse wave modulator. For example, the voltage requirement of the control block (not shown) in the bridging control unit 15 may be 3.3 volts, and the voltage requirements of the bridge block (not shown) are 3.3 volts and 1.2 volts, so that the voltage converter circuit 18 provides 3.3 volts voltage to the control block (not shown) and the bridge block (not shown), and provides 1.2 volts voltage to the bridge block (not shown). The exemplary embodiment of the present disclosure doesn't limit the type of the voltage converter circuit 18 supplying power to the bridging control unit 15.

For example, when the external storage device 1d is coupled to the electronic device 9 through the transmission line 20a, the electronic device 9 will detect the type of the external storage device 1d, so as to identify communication protocol of USB 3.0 used by the external storage device 1d. The bridging control unit 15 may perform a conversion to output SATA signal, so that the bridging control unit 15 will consume more power, so as to provide two sets of voltage to the bridging control unit 15, to preserve normal operation with the external storage device 1d.

According to the above-mentioned reasons, the external storage device 1d of the present disclosure receives a power provided from the electronic device 9 through the transmission line 20a, and then the power is transmitted and supplied directly to the hard disks 10 through the connecting port 16 to drive the hard disks 10. In addition, the voltage converter circuit 18 of the present disclosure converts voltages into suitable voltages to meet the voltage requirements of the bridging control unit 15. In this way, the bridging control unit 15 can provide SATA signal to control the hard disks 10 to operate data access and data backup. By the above-mentioned mechanisms, the driving circuit design of the external storage device 1d can be simplified, and the using of energy and the efficiency of energy-saving can also be promoted.

Accordingly, those skilled in the art should know that the basic operation of the sixth exemplary embodiment is essentially the same as the first exemplary embodiment, and should be able to infer the operation associated with the sixth exemplary embodiment, further descriptions are therefore omitted.

### Seventh Exemplary Embodiment

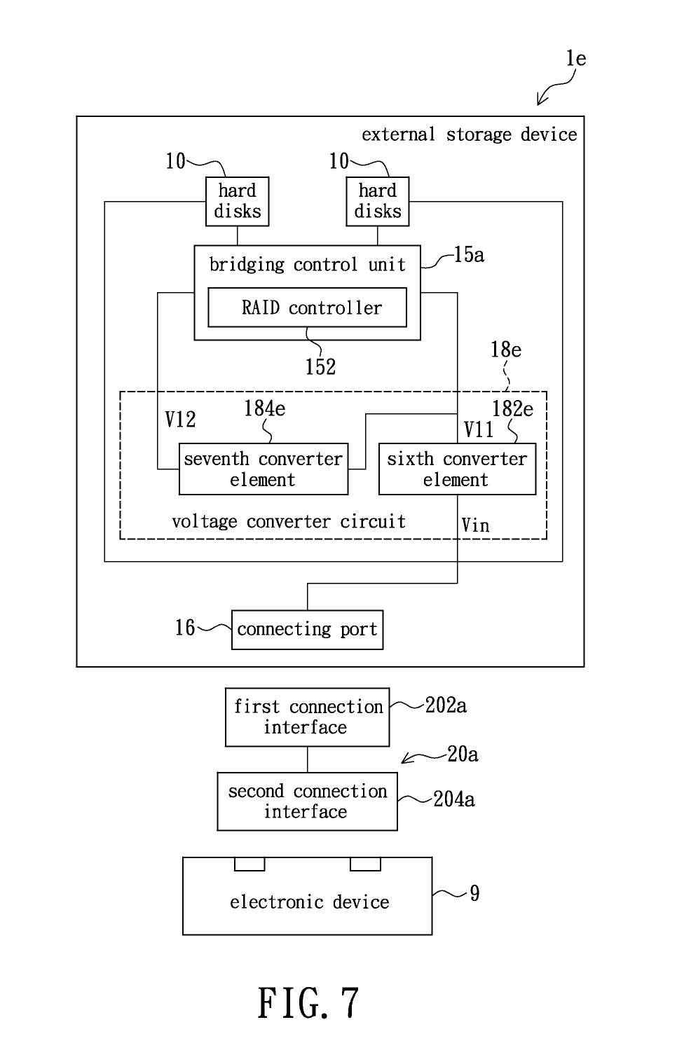

FIG. 7 is a function block diagram of an external storage device according to another exemplary embodiment of the present disclosure. Please refer to FIG. 7. The structures of the external storage device 1e (in FIG. 7) and the external storage device 1d (in FIG. 6) are similar to each other, while the same elements of both storage devices could be indicated by the same reference numerals in the following exemplary embodiment. The differences between the external storage device 1e and 1d are that: The voltage converter circuit 18e comprises a sixth converter element 182e and a seventh converter element 184e, while the sixth converter element 182e is coupled to the bridging control unit 15a, the seventh converter element 184e and the connecting port 16. The seventh converter element 184e is coupled to the bridging control unit 15a.

In practice, the sixth converter element 182e is a pulse wave modulator or a low voltage-drop regulator, and the seventh converter element 184e is a pulse wave modulator or a low voltage-drop regulator, so that the number of the combinations of the sixth converter element 182e and the seventh converter element 184e is four. Each combination can provide voltages required by the bridging control unit 15a. The exemplary embodiment of the present disclosure merely proposes one embodiment to introduce the contents of the present disclosure. Those skilled in the art should be able to deduce the other embodiments about using a pulse wave modulator or a low voltage-drop regulator to change the combinations of the sixth converter element 182e and the seventh converter element 184e according to the disclosure of the present invention, and the description is omitted.

In addition, the voltage converter circuit 18e converts the power to a first voltage V11 and a second voltage V12, while the voltage converter circuit 18e provides the first voltage V11 and the second voltage V12 to the bridging control unit 15a. The exemplary embodiment of the present disclosure doesn't limit the values of the first voltage V11 and the second voltage V12, and those skilled in the art should be able to deduce the other embodiments according to their actual demands.

For example, the sixth converter element 182e is a pulse wave modulator, and the seventh converter element 184e is a low voltage-drop regulator. The pulse wave modulator has an input port and an output port, and the low voltage-drop regulator also has an input port and an output port. The pulse wave modulator is coupled to the low voltage-drop regulator, and the pulse wave modulator and the low voltage-drop regulator are coupled to the bridging control unit 15a.

In detail, the sixth converter element 182e may output the first voltage V11, while the first voltage V11 is supplied to the bridging control unit 15a and the seventh converter element 184e. The seventh converter element 184e receives the first voltage V11 and converts it into the second voltage V12 that is supplied to the bridging control unit 15a.

For example, the connecting port 16 receives 5V voltage provided from the electronic device 9, and the 5V voltage is supplied to the hard disks 10 to drive and operate the hard disks 10 normally. The sixth converter element 182e receives the power and converts it into the first voltage V11 (3.3 V), while the first voltage V11 is supplied to the bridging control unit 15a and the seventh converter element 184e. The seventh converter element 184e converts it into the second voltage V12 (1.2 V), while the second voltage V12 is supplied to the bridging control unit 15a.

It is worth noting that the bridging control unit 15a comprises a RAID controller 152 used for transmitting the SATA signal to each of the hard disks 10, so that the hard disks 10 can be integrated into a plurality of redundant arrays of independent disks. In practice, storage modes of the redundant array of independent disks have many different types, such as RAID0, RAID1, RAID0+1, RAID2, RAID3, RAID4, RAID5, RAID6, RAID7, RAID10, RAID30 and RAID50 of different RAID application levels. The electronic device 9 takes the hard disks 10 as a single hard disk or a single logical storage drive. Of course, the RAID controller 152 also has functions for enhancing data integration, strengthening fault tolerance, and expanding capacity, thereby integrating the hard disk into a plurality of redundant arrays of independent disks. The redundant arrays of independent disks can be divided into different storage modes to achieve more effective transmission efficiency and data guard function to protect the information security of the hard disks 10.

Accordingly, those skilled in the art should know that the basic operation of the seventh exemplary embodiment is essentially the same as the sixth exemplary embodiment, and should be able to infer the operation associated with the seventh exemplary embodiment, further descriptions are therefore omitted.

### Eighth Exemplary Embodiment

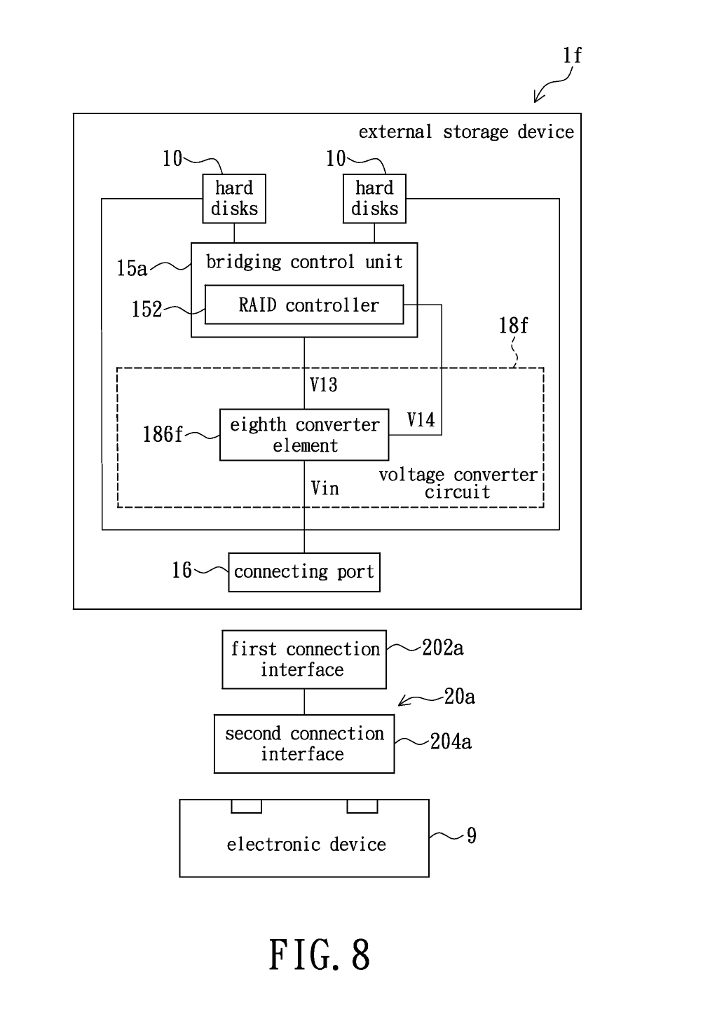

FIG. 8 is a function block diagram of an external storage device according to another exemplary embodiment of the present disclosure. Please refer to FIG. 8. The structures of the external storage device if (in FIG. 8) and the external storage device 1e (in FIG. 7) are similar to each other. For example, the external storage device if also could receive the power of the electronic device 9, and directly supply the power to each of hard disks 10. However, the differences between the external storage device if and le are that: the voltage converter circuit 18f comprises an eighth converter element 186f, while the eighth converter element 186f is coupled to the connecting port 16 and the bridging control unit 15a.

In detail, the eighth converter element 186f may be a dual-output-port pulse wave modulator, so that the eighth converter element 186f could output the first voltage V13 and the second voltage V14 respectively, while the first voltage V13 and the second voltage V14 are respectively supplied to the bridging control unit 15a.

For example, the connecting port 16 receives 5V voltage provided from the electronic device 9, and the 5V voltage is supplied to the hard disks 10 to drive and operate the hard disks 10 normally. The eighth converter element 186f receives the said 5V voltage and converts it into the first voltage V13 (3.3V) and the second voltage V14 (1.2V). For example, the first voltage V13 is supplied to the control block (not shown) and the bridge block (not shown) of the bridging control unit 15a, while the second voltage V14 is supplied to the bridge block (not shown) of the bridging control unit 15a. The exemplary embodiment doesn't limit the operation types of the first voltage V13 and the second voltage V14 supplied to the bridging control unit 15a.

Accordingly, those skilled in the art should know that the basic operation of the eighth exemplary embodiment is essentially the same as the seventh exemplary embodiment, and should be able to infer the operation associated with the eighth exemplary embodiment, further descriptions are therefore omitted.

### Ninth Exemplary Embodiment

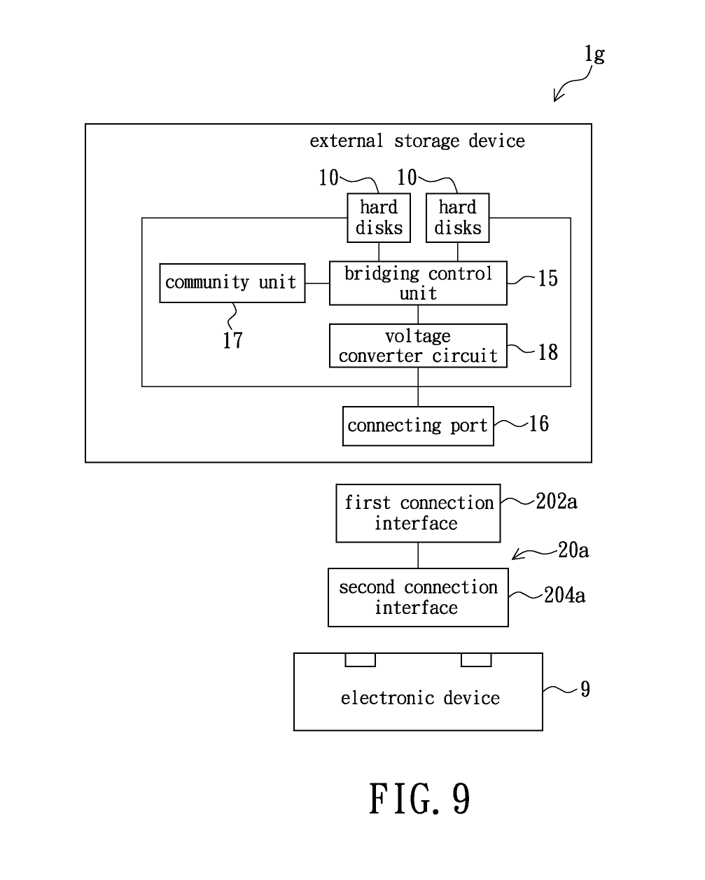

FIG. 9 is a function block diagram of an external storage device according to another exemplary embodiment of the present disclosure. Please refer to FIG. 9. The structures of the external storage device 1g (in FIG. 9) and the external storage device 1d (in FIG. 6) are similar to each other. For example, the external storage device 1g also can receive a power provided from the electronic device 9 and supply the power directly to each of the hard disks 10. However, there are still some differences between the external storage device 1g and 1d, and these differences are that: the external storage device 1g furthermore comprises a community unit 17, while the community unit 17 is coupled to the bridging control unit 15, and the community unit 17 is used to wirelessly receive a data signal to the bridging control unit 15.

In practice, the community unit 17 may be, for instance, a Bluetooth communication transceiver, a Wireless LAN communication transceiver, a Wireless PAN communication transceiver, a Wi-Fi communication transceiver, an IEEE 802.11 communication transceiver or a ZigBee (802.15.4) communication transceiver. The type of the community unit 17 of the present invention is not limited, and those skilled in the art may perform a free design according to requirement.

The community unit 17 may be, for example, a Bluetooth communication transceiver, and the smart phone used by the user also comprises a Bluetooth communication modulation. Therefore, the user could operate the smart phone to wirelessly transmit personal data in the smart phone to the external storage device 1g, or wirelessly take the data in the external storage device 1g to the smart phone, so as to achieve data access and data backup jobs.

By the same token, the user could use smart phone, tablet pc, notebook computer, mobile phone or personal digital assistant (PDA) or other wireless devices etc. that can wirelessly communicate with the community unit 17 of the external storage device 1c. The types of above-mentioned wireless devices are not limited in this exemplary embodiment. In addition, the exemplary embodiment uses single wireless device wirelessly connected to the external storage device 1g, so as to achieve data access and data backup jobs. In another exemplary embodiment, there are many wireless devices wirelessly connected to the external storage device 1g, and meanwhile the said wireless devices could perform data access operations. The quantity of the said wireless devices (not shown) is not limited in the exemplary embodiment.

For example, when the said many wireless devices are wirelessly connected to the external storage device 1g for performing data access operations, the bridging control unit 15 controls hard disks 10 to perform data access operations according to sequence of data access instructions based on the said wireless devices. Certainly, the bridging control unit 15, according to its own program, could control the priorities of data access instructions based on the said wireless devices. The operation mode of the bridging control unit 15 is not limited in the exemplary embodiment. Furthermore, in another exemplary embodiment, the community unit 17 could be a unidirectional wireless transmitter or a unidirectional wireless receiver, so that the operation mode of the community unit 17 is not limited in the exemplary embodiment.

In addition, the external storage device 1g of the exemplary embodiment is coupled to the electronic device 9 through the transmission line 20a, while the electronic device 9 supplies the power to the external storage device 1g. Certainly, the user could operate the electronic device 9, so that personal data in the electronic device 9 is transmitted to the external storage device 1g through wire, or data in the external storage device 1g is accessed by the electronic device 9 through wire, so as to achieve data access and data backup jobs. The data access operation between the external storage device 1c and the electronic device9 is not limited in the exemplary embodiment.

As can be known here, the external storage device 1g of the exemplary embodiment comprises two kinds of data access methods, wherein one method uses wireless means for data access operations based on the community unit 17, and the other method uses wire means for data access operations based on the transmission line 20a. Those skilled in the art may perform a free design according to requirement. It is worth noting that the bridging control unit 15a of the exemplary embodiment could supply power to the community unit 17. In another exemplary embodiment, the voltage converter circuit 18e could supply power to the community unit 17, and those skilled in the art may perform a free design according to requirement.

Accordingly, those skilled in the art should know that the basic operation of the ninth exemplary embodiment is essentially the same as the sixth exemplary embodiment, and should be able to infer the operation associated with the ninth exemplary embodiment, further descriptions are therefore omitted.

In summary, the spirit of the present disclosure mainly uses the transmission line coupled between the external storage device and the electronic device, and the power provided from the electronic device is directly supplied to the hard disks through the transmission line, and then the power is converted into suitable voltages through a voltage converter circuit to meet the voltage requirements of the control unit and the bridging unit, whereby the control unit can control the data access of the hard disks. In addition, the power is converted into suitable voltages through the voltage converter circuit to meet the voltage requirements of the bridging control unit, whereby the bridging control unit can control the data access of the hard disks.

Furthermore, the control unit (or bridging control unit) comprises a RAID controller, thereby providing the hard disks different storage modes in order to achieve effective transmission efficiency and data guard function to protect the information security of the hard disks. The external storage device furthermore comprises a community unit, while the community unit is used to wirelessly transmit/receive a data signal for the bridging control unit to operate data access and data backup. By the above-mentioned mechanisms, the driving circuit design of the external storage device can be simplified and the using of energy and the efficiency of energy-saving can be promoted.

The above-mentioned descriptions represent merely the exemplary embodiment of the present disclosure, without any intention to limit the scope of the present disclosure thereto. Various equivalent changes, alternations or modifications based on the claims of the present disclosure are all consequently viewed as being embraced by the scope of the present disclosure.

What is claimed is:

1. An external storage device, comprising:
a plurality of hard disks;
a control unit, electrically coupled to the hard disks for integrating the hard disks into a plurality of redundant arrays of independent disks (RAID's);
a bridging unit, electrically coupled to the control unit;
a connecting port, electrically coupled to the hard disks; and
a voltage converter circuit, electrically coupled to the control unit, the bridging unit, and the connecting port;
wherein the external storage device receives through a transmission line a power provided from an electronic device, and the power is directly transmitted to the hard disks through the connecting port to drive the hard disks; and the voltage converter circuit converts the power and supplies the power to the control unit and the bridging unit.

2. The external storage device according to claim 1, wherein the transmission line is a Y-shaped transmission line, which comprises a first connection interface, a second connection interface and a third connection interface; the first connection interface is electrically coupled to the connecting port, and a specification of the connecting port is USB 3.0 or USB 2.0; the second connection interface and the third connection interface are electrically coupled to an output-connecting port of electronic devices, and a specification of the second connection interface is USB 3.0; and a specification of the third connection interface is USB 3.0 or USB 2.0.

3. The external storage device according to claim 1, wherein the transmission line is a single cable transmission line, and comprises a first connection interface and a second connection interface; the first connection interface is electrically coupled to the connecting port, and a specification of the connecting port is USB 3.0; the second connection interface is electrically coupled to an output-connecting port of electronic devices, and a specification of the second connection interface is USB 3.0.

4. The external storage device according to claim 1, wherein the voltage converter circuit converts the power to a first voltage, a second voltage and a third voltage, and the voltage converter circuit provides the first voltage and the second voltage to the control unit, and provides a first voltage and a third voltage to the bridging unit.

5. The external storage device according to claim 1, wherein the voltage converter circuit comprises a first converter element, a second converter element and a third converter element, the first converter element is electrically coupled between the second converter element and the third converter element.

6. The external storage device according to claim 5, wherein the first converter element is a pulse wave modulator or a low voltage-drop regulator, the second converter element is a pulse wave modulator or a low voltage-drop regulator, and the third converter element is a pulse wave modulator or a low voltage-drop regulator.

7. The external storage device according to claim 1, wherein the voltage converter circuit comprises a fourth converter element and a fifth converter element, and the fourth converter element is electrically coupled to the fifth converter element.

8. The external storage device according to claim 7, wherein the fourth converter element is a dual-output-port pulse wave modulator, the fifth converter element is a low voltage-drop regulator, and a port of the fourth converter element is electrically coupled to the fifth converter element.

9. The external storage device according to claim 7, wherein the fourth converter element is a low voltage-drop regulator, the fifth converter element is a dual-output-port pulse wave modulator, and the fourth converter element is electrically coupled to an input-port of the fifth converter element.

10. The external storage device according to claim 1, wherein the bridging unit is used to convert a USB signal into a SATA signal, and transmits the SATA signal to the control unit, the control unit comprises a RAID controller for integrating the hard disks into the RAID's, and the RAID controller divides the RAID's into different storage modes to provide better transmission efficiency and to achieve data backup function, wherein each of the hard disks is a 2.5-inch hard disk.

11. A driving method of an external storage device, comprising:
providing a transmission line coupled between an external storage device and an electronic device;
determining whether a connecting port of the external storage device receives a power supplied from the electronic device;
if the connecting port of the external storage device receives the power supplied from the electronic device, the power is transmitted directly to the hard disks through the connecting port; and
by using a voltage converter circuit of the external storage device, converting the power and supplying the power to the control unit and the bridging unit.

12. An external storage device, comprising:
a plurality of hard disks;
a bridging control unit, electrically coupled to the hard disks for integrating the hard disks into a plurality of redundant arrays of independent disks (RAID's);
a connecting port, electrically coupled to the bridging control unit and the hard disks; and
a voltage converter circuit, electrically coupled to the bridging control unit and the connecting port;
wherein the external storage device receives through a transmission line a power provided from an electronic device, and the power is directly transmitted to the hard disks through the connecting port to drive the hard disks; and the voltage converter circuit converts the power and supplies the power to the bridging control unit.

13. The external storage device according to claim 12, wherein the transmission line comprises a first connection interface and a second connection interface; the first connection interface is electrically coupled to the connecting port, and a specification of the connecting port is USB 3.0 or USB 2.0; the second connection interface is electrically coupled to an output-connecting port of electronic device, and a specification of the second connection interface is USB 3.0 or USB 2.0.

14. The external storage device according to claim 12, wherein the voltage converter circuit converts the power to a first voltage, and the voltage converter circuit provides the first voltage to the bridging control unit.

15. The external storage device according to claim 14, wherein the voltage converter circuit is a pulse wave modulator or a low voltage-drop regulator.

16. The external storage device according to claim 12, wherein the voltage converter circuit converts the power to a first voltage and a second voltage, and the voltage converter circuit provides the first voltage and the second voltage to the bridging control unit.

17. The external storage device according to claim 16, wherein the voltage converter circuit comprises a first converter element and a second converter element, while the first converter element is electrically coupled to the second converter element, the first converter element is a pulse wave modulator or a low voltage-drop regulator, and the second converter element is a pulse wave modulator or a low voltage-drop regulator.

18. The external storage device according to claim 16, wherein the voltage converter circuit is a third converter element, while the third converter element is a dual-output-port pulse wave modulator.

19. The external storage device according to claim 12, wherein the transmission line is a single cable transmission line, and comprises a first connection interface and a second connection interface; the first connection interface is electrically coupled to the connecting port, and a specification of the connecting port is USB 3.0; the second connection interface is electrically coupled to an output-connecting port of the electronic device, and a specification of the second connection interface is USB 3.0.

20. The external storage device according to claim 12, wherein the bridging control unit is used to convert a USB signal into a SATA signal, and transmits the SATA signal to the bridging control unit, the bridging control unit comprises a RAID controller for integrating the hard disks into the RAID's, and the RAID controller divides the RAID's into different storage modes to provide better transmission efficiency and to achieve data backup function, wherein each of the hard disks is a 2.5-inch hard disk drive or a solid-state disk.

21. The external storage device according to claim 12, furthermore comprising a community unit, the community unit being electrically coupled to the bridging control unit, while the community unit is used to wirelessly receive and/or transmit a data signal.
